(19) United States
(12) Patent Application Publication
(10) Pub. No.: US 2020/0175531 A1
(43) Pub. Date: Jun. 4, 2020

(54) METHOD AND SYSTEM FOR RESERVING STOCK IN A REGIONAL DISTRIBUTION CENTER

(71) Applicants: Beijing Jingdong Shangke Information Technology Co., Ltd., Beijing (CN); JD.com American Technologies Corporation, Mountain View, CA (US)

(72) Inventors: Chenxin Ma, Mountain View, CA (US); Rong Yuan, Mountain View, CA (US); Jie Lu, Mountain View, CA (US); Di Wu, Mountain View, CA (US)

(21) Appl. No.: 16/208,475

(22) Filed: Dec. 3, 2018

Related U.S. Application Data
(63) Continuation-in-part of application No. 16/208,439, filed on Dec. 3, 2018.

(51) Int. Cl. G06Q 30/02; G06Q 10/08; G06F 17/16

(52) U.S. Cl. CPC G06Q 30/0202; G06Q 10/083; G06F 17/16; G06Q 10/0875

(57) ABSTRACT

Systems and methods for providing reserve ratio of a product in a first level distribution center. The method includes: providing, by a computing device, demand forecasts in a first predetermined time, inventory and sale loss data of the product in the first and second level distribution centers; defining an object function having components of first level cost due to out of stock of the product at the first level distribution center, second level cost due to out of stock of the product at the second level distribution center, and delivery cost due to out of stock of the product at the second level distribution center and delivery of the product from the first level distribution center, using the demand forecasts, inventory and sale loss data of the product; and minimizing the object function to obtain the reserve ratio of the product in the first level distribution center.

### CROSS-REFERENCES

This application is a continuation-in-part application of U.S. application Ser. No. 16/208,439, filed Dec. 3, 2018, entitled “METHOD AND SYSTEM FOR TWO-ECHELON INVENTORY ALLOCATION,” by Jie Lu et al. The entire disclosure of each of the above-identified applications is incorporated herein by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates generally to the field of e-commerce, and more particularly to methods and systems for efficiently reserving inventory at a high level distribution center in a two-echelon inventory allocation system.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

E-commerce has undergone a hyper growth for years and giant online retail platforms provide millions of products for customers to choose from. For a pleasant online shopping experience, the customer may expect convenient order process and fast delivery of the purchased products. To facilitate the delivery of the products, some e-commerce providers have set up distribution centers and warehouses at different locations. However, allocation of products among those distribution centers is a hard task.

Therefore, an unaddressed need exists in the art to address the aforementioned deficiencies and inadequacies.

### SUMMARY

In certain aspects, the present disclosure relates to a method for providing reserve ratio of a product in a first level distribution center. In certain embodiments, the method includes:

providing, by a computing device, demand forecasts in a first predetermined time, inventory and sale loss data of the product in the first level distribution center and a second level distribution center, the second level distribution center covered by the first level distribution center;

defining, by the computing device, an object function comprising components of first level cost due to out of stock of the product at the first level distribution center, second level cost due to out of stock of the product at the second level distribution center, and delivery cost due to out of stock of the product at the second level distribution center and delivery of the product from the first level distribution center, using the demand forecasts, inventory and sale loss data of the product; and

minimizing the object function to obtain the reserve ratio of the product in the first level distribution center.

In certain embodiments, the object function includes:

$$\begin{matrix}{min}_{δ , y} {{Σ}_{k} ( {d}_{0}^{k} + ( 1 - α ) {y}^{k} - {δ}_{0} I )}^{+} + {Σ}_{k} α {y}^{k} + {Σ}_{k} θ min \{ ( 1 - α ) {y}^{k} , \frac{( 1 - α ) {d}_{1}^{k}}{{d}_{0}^{k} + ( 1 - α ) {d}_{1}^{k}} {( {δ}_{0} I - \frac{{d}_{0}^{k}}{{d}_{1}^{k}} {δ}_{1} I )}^{+} \} , \\ where \text{:} & ( 1 ) \\ {δ}_{0} + {δ}_{1} \leq 1 , & ( 1 a ) \\ {y}^{k} \geq {d}_{1}^{k} - {δ}_{1} I , ∀ k , and & ( 1 b ) \\ {y}^{k} \geq 0 , ∀ k . & ( 1 c )\end{matrix}$$

I is a total current inventory of the product at the first level distribution center, δ represents allocation ratio of the inventory I, δ₀ represents allocation ratio of the product for the first level distribution center, δ₁ represents allocation ratio of the product for the second level distribution center.

k is an index of scenarios being a positive integer from 1 to K, ∀k means for all the K scenarios.

d₀^{k} is demand forecast of the first level distribution center under a kth scenario in a predetermined time, and d₁^{k} is demand forecast of the second level distribution center under the kth scenario in the predetermined time.

y^{k} represents sale loss of the product at the second level distribution center under the kth scenario, θ represents the ratio of expediting transportation cost if shipping the product from the first level distribution center to the customer directly over stockout cost of the product in the first level distribution center, α represents cancellation rate incurred due to stockout of the product in the second level distribution center.

In certain embodiments, θ is a predetermined number that is in a range of about 10%-50% of a unit price of the product. In certain embodiments, θ is determined based on attributes of the product. In certain embodiments, α is a predetermined number in a range of about 0-0.2. In certain embodiments, θ is 10% of the unit price of the product and α is 0.1.

In certain embodiments, K is a predetermined number in a range of 50-200. In certain embodiments, K is about 100. In certain embodiments, each of the demand forecasts is a vector comprising K scenarios. In certain embodiments, the predetermined time is in a range of one day to seven days. In certain embodiments, the predetermined time is two days.

In certain embodiments, the method further includes: allocating the product from the first level distribution center to the second level distribution center based on the reserve ratio.

In certain aspects, the present disclosure relates to a system for providing reserve ratio of a product in a first level distribution center. The system includes a computing device. The computing device includes a processor and a storage device storing computer executable code. The computer executable code, when executed at the processor, is configured to perform the method described above.

In certain aspects, the present disclosure relates to a non-transitory computer readable medium storing computer executable code. The computer executable code, when executed at a processor of a computing device, is configured to perform the method as described above.

These and other aspects of the present disclosure will become apparent from following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The accompanying drawings illustrate one or more embodiments of the disclosure and together with the written description, serve to explain the principles of the disclosure. Wherever possible, the same reference numbers are used throughout the drawings to refer to the same or like elements of an embodiment.

FIG. 1 schematically depict an example of an allocation system according to certain embodiments of the present disclosure.

FIG. 2 schematically depicts inventory flow of a product in a two-echelon inventory allocation system according to certain embodiment of the present disclosure.

FIG. 3 schematically depicts a process of determining reserve ratio for a first level distribution center according to certain embodiments of the present disclosure.

FIG. 4 schematically depicts a computing system of a two-echelon inventory allocation system according to certain embodiment of the present disclosure.

FIG. 5 schematically depicts a method of allocating inventory according to certain embodiments of the present disclosure.

FIG. 6 schematically depicts a two-echelon inventory allocation system according to certain embodiment of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Unless otherwise defined, “first”, “second”, “third” and the like used before the same object are intended to distinguish these different objects, but are not to limit any sequence thereof.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially” or “approximately” can be inferred if not expressly stated.

As used herein, “plurality” means two or more.

As used herein, the terms “comprising”, “including”, “carrying”, “having”, “containing”, “involving”, and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure. As used herein, the term “and/or” includes any and all combinations of one or more of the associated listed items.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as limited to the embodiments set forth herein; rather, these embodiments are provided so that this disclosure will be thorough and complete, and will fully convey the scope of the present disclosure to those skilled in the art.

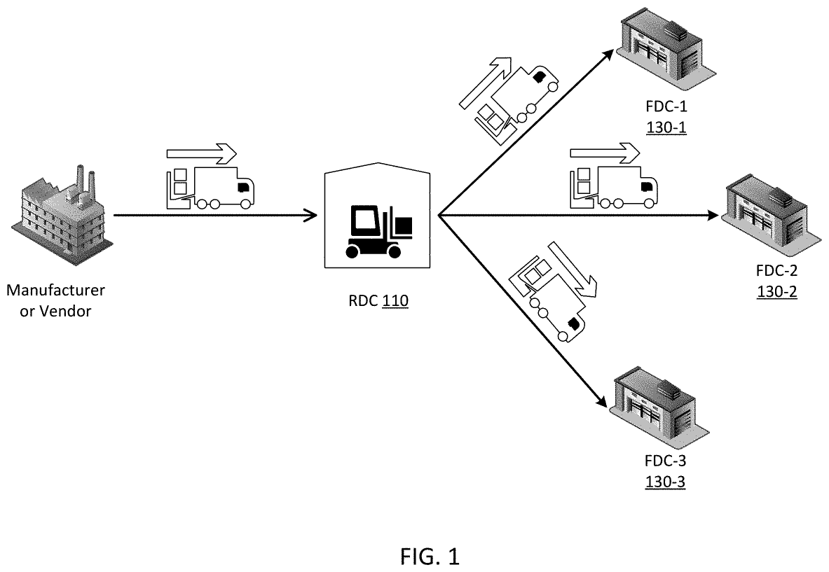

FIG. 1 schematically depict an example of an allocation system according to certain embodiments of the present disclosure. As shown in FIG. 1, the system includes a regional distribution center (RDC) 110 and several front distribution centers (FDCs) 130, e.g., FDC-1 (130-1), FDC-2 (130-2) and FDC-3 (130-3). The RDC 110 is a high level distribution center that is responsible for replenishing the FDCs 130 within its coverage and the delivery of products to its associated metropolitan area and its surrounding areas. Each FDC 130 is a lower level distribution center that is responsible for the delivery to its associated metropolitan area and its surrounding areas. When the RDC 110 places an order for one SKU or product, the corresponding manufacturer or vendor ships the SKU within a vendor lead time (VLT). The RDC 110 allocates the inventory of the SKU among the RDC 110 and the FDCs 130, and transports certain amount of the SKU to the FDCs 130. In certain embodiments, the allocation is based on the demands and the inventory of the RDC 110 and the FDCs 130, and optionally the SKU price and loss information.

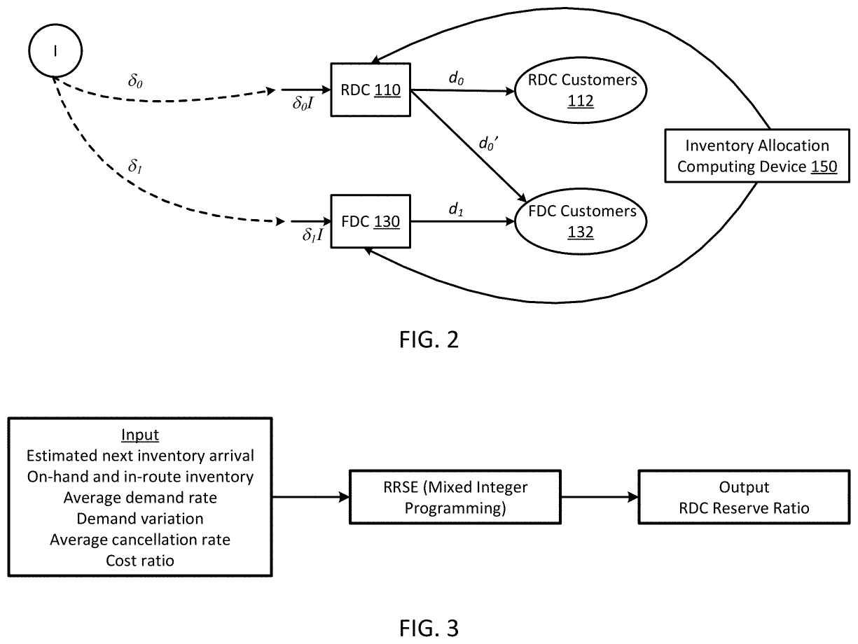

To allocate the inventory of one product among the RDC 110 and the FDCs 130 optimally, at first, the input of the product to the RDC 110 and the FDCs 130 and the output of the product from the RDC 110 and the FDCs 130 to the customers need to be identified. FIG. 2 schematically depicts flow of a product in the two-echelon inventory allocation system according to certain embodiment of the present disclosure. Kindly note that only one RDC 110 and one FDC 130 are shown in FIG. 2. However, in practice, there may be multiple, such as 5-20 RDCs 110 in a country; and each RDC 110 may cover multiple, such as 3-10 FDCs 130. Therefore, the example shown in FIG. 2 should be understood as a process relating to one RDC 110 and multiple FDCs 130 covered by the RDC 110. As shown in FIG. 2, for one product, when an inventory I is available in the RDC 110 at the current time, the system may keep a reserve ratio δ₀ of the inventory I in the RDC 110, and deliver all or part of an allocation ratio δ₁ of the inventory I in the RDC 110 to the FDC 130. Here the sum of the ratio δ₀ and the ratio δ₁ equals to or is less than 1. The inventory of the product in the RDC 110 is used to meet the demand d₀ by the RDC customers 112, and the inventory of the product in the FDC 130 is used to meet the demand d₁ by the FDC customers 132. When the stock of the product in the FDC 130 is not sufficient to meet the demand d₁, the RDC 110 may directly fulfil certain orders by the FDC customers 132, which fulfillment is termed d′₀.

Inventory allocation from the RDC 110 to the FDCs 130 is the key operational process that keeps sufficient inventories at the FDC level. This process is important as stockout at FDCs 130 may jeopardize the delivery speed promise to the FDC customers 132 as shipping from the RDC 110 to the FDC customers 132 could take much longer time than shipping from the FDCs 130. The control of the frequency and amount of inventory allocation from the RDC 110 to the FDCs 130 is the key decision in this process.

While allocating inventory to the FDCs 130 is important, it is more crucial that we do not over-commit the inventory to FDCs 130. If shipping too many inventories to FDCs 130, we put the RDC 110 itself at risk. Keeping a safety inventory level at RDC 110 is critical not only because there is a lot demand that is needed to be directly covered by the RDC 110 (RDCs 110 are associated with metropolitan cities), but also that inventory at the RDC 110 can be used to support any of the FDCs 130 within its coverage when needed. The central position of the RDC 110 implies that storing some buffer inventory at the RDC is usually beneficial as it can provide additional flexibility to the demand variability (Kindly note that inventory allocated to an FDC 130 usually cannot be shipped again to another FDC 130 or back to the RDC 110).

As described above, the key decision here is to set a safety inventory level at the RDC 110 such that (1) it protects the RDC 110 from stockout; (2) it keeps some buffer inventory at the RDC 110 to provide flexibility for future demand variability, as well as (3) it allocates inventory to the FDCs 130 as much as possible given RDC 110's safety stock is ensured. This is a difficult problem as there are trade-offs between stockout risk at the RDC 110 and at the FDCs 130. The key problem is how to control the inventory balance between the RDC 110 and the FDCs 130.

In certain aspects, the present disclosure set the inventory reserve ratio at an RDC 110 manually. The RDC reserve ratio is set at a number between 0 and 1, indicating what percentage of the current RDC inventory should be reserved at the RDC 110 by the end of the day. The granularity of this setting is for each product at each sales region, or in other words, for each SKU at each RDC 110. Given hundreds of thousands products and multiple, such as eight regional distribution centers, there are more than a million RDC reserve ratio parameters that need to be set for the inventory allocation decision. As the magnitude is beyond the limit that human can manage in daily operations, in certain embodiments, each of the reserve ratio parameters may be set at a fixed number for a group of products. The disadvantages of this manual approach include: (1) Cannot differentiate among products. The products that have different demand patterns should be treated differently. For example, if product A has a larger demand variability than product B, the RDC 110 should reserve a higher level of inventory of product A to hedge against foreseeable demand variability; (2) Cannot differentiate along time. The reserve ratio of the same product should be able to be adjusted dynamically. For example, if the inventory at the RDC 110 is very high comparing to the demand in the region, we should be able to lower the reserve ratio in order to allow more inventory to be allocated to the FDCs 130 covered by that RDC 110; (3) Cannot take the next inventory arrival time into account. This has the same spirit as previously described in (2) but focusing on the next inventory arrival time. For example, if we know the next batch of inventory will arrive tomorrow and we still have quite a lot inventory left at the RDC 110, we should be able to lower the reserve ratio at the RDC 110 so that more inventory can be pulled into the FDCs 130.

To improve the above manual setting of the reserve ratio of a product, in certain aspects, the present disclosure provides a Regional Reserve Stock Engine (RRSE) to estimate the optimal reserve ratio for each product in each of the RDCs 110. In certain embodiments, the RRSE considers a variety of factors that are not considered in the manual setting and offers a near-optimal solution of the reserve ratio at the RDC 110 for each product at each sales region. These factors include: (1) the current on-hand and in-route inventory at/to the RDC 110 and the FDCs; (2) the average demand forecast for the RDC 110 and the FDCs 130; (3) the demand variation at the RDC 110 and the FDCs 130; (4) the average cancellation rate if the customer gives up the purchase due to a longer delivery time; and (5) the ratio of the stockout cost of the product over the expediting transportation cost if shipping the product from RDC to the customer directly.

In certain embodiments, the RRSE collects these data automatically in the morning each day and process them in real time to give an RDC inventory reserve ratio recommendation for each product at each sales region. The reserve ratio is multiplied by the current inventory on-hand at RDC 110 in order to give a safety stock level—inventory that cannot be allocated to the FDCs 130 by the end of the day. Or equivalently, one minus the reserve ratio is the amount of inventory that can be allocated to the FDCs 130 on the day. In certain embodiments, this process is performed by the inventory allocation computing device 150 and the process is summarized in FIG. 3.

FIG. 3 schematically depicts an RRSE process according to certain embodiments of the present disclosure. As shown in FIG. 3, the RRSE first retrieve a variety of parameters from different resources as input, which may include, among other things, estimated next inventory arrival time, on-hand and in-route inventory, average demand rate, demand variation, average cancellation rate, and cost ratio. Then the RRSE uses those parameters to optimize a mixed-integer programming model, so as to obtain an optimal RDC reserve ratio for a specific product in a specific RDC 110. With this reserve ratio, the amount of the product need to be reserved in the RDC 110 is known, and the quantity of the product that is available for being delivered to the FDCs 130 under this RDC 110 is determined. An allocation system can then use the reservation ratio as a guidance, together with the request from the FDCs 130, to calculate how to allocate all or part of the available product to the FDCs 130.

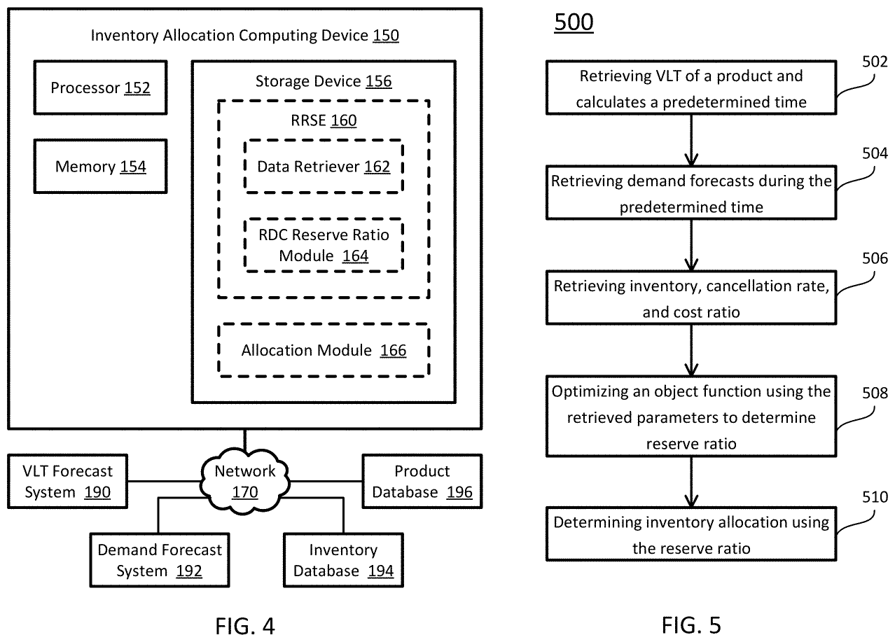

FIG. 4 schematically shows a computing system for performing the RRSE function according to certain embodiments of the present disclosure. As shown in FIG. 4, the computing system includes an inventory allocation computing device 150, and the inventory allocation computing device 150 is in communication with, via a network 170, external data or services including a vendor lead time (VLT) forecast system 190, a demand forecast system 192, an inventory database 194, and a product database 196. In certain embodiments, the network 170 may be a wired or wireless network, and may be of various forms. Examples of the network 170 may include, but is not limited to, a local area network (LAN), a wide area network (WAN) including the Internet, or any other type of networks. The best-known computer network is the Internet.

The inventory allocation computing device 150 is configured to determine the optimal reserve ratio for the RDC 110, and optionally allocate inventory between the RDC 110 and the FDCs 130 based on the reserve ratio. When the computing device 150 is only configured to determine the reserve ratio, it may also term as reserve ratio computing device based on its function. In certain embodiments, the inventory allocation computing device 150 may be a server computer, a cluster, a cloud computer, a general-purpose computer, or a specialized computer, which can collect demand forecast, inventory, and cost information of the RDC 110 and the FDCs 130, and provide the reserve ratio of the RDC 110.

The VLT forecast system 190 may include a computing device such as a cloud computing device that provides prediction of the VLT for each product from a vendor or manufacturer. In certain embodiments, the forecast of the VLT is estimated mainly based on the historical ordering of the product and delivering of the product by the vendor or manufacturer.

The demand forecast system 192 may include a computing device such as a cloud computing device that provides predictions of the demands of the RDC 110 and the FDCs 130 mainly based on historical data. In certain embodiments, the demand forecast system 192 provides each SKU a daily forecast for the future time. In certain embodiments, each daily forecast may be a number of units or a range of a number of units of the SKU. For example, a daily forecast for a SKU in the next seven days may be respectively 200 units, 220 units, 280 units, 230 units, 200 units, 170 units, 190 units; or respectively 170-220 units, 200-240 units, 260-310 units, 200-260 units, 190-210 units, 170-190 units, 170-200 units. In certain embodiments, the forecast may also be a total number of units for the SKU in a predetermined time period, such as next 5 days. The daily forecast or forecast for a period of time may be a specific number of units, a specific number of units with a variance, or a distribution of numbers of units. In certain embodiments, the demand forecast is equivalent to or close to sales forecast, which is the estimation of the sales of the product in the future time.

The inventory database 194 is stored in a computing device such as a cloud computing device that records inventory of the RDC 110 and the FDCs 130 and optionally other inventory related information and analysis. For example, when the inventory is on the route from a vendor or manufacture to the RDC 110, the quantity of the product is recorded and the arrival time of the inventory to the RDC 110 is estimated.

The product database 196 is stored in a computing device such as a cloud computing device that provides product information. Each product has an SKU as identification. The product information of an SKU may include the identification of the product (i.e., the SKU), the category of the product, the name or title of the product, the dimensions and weight of a unit of the product, the color of the product, the unit price of the product, the direct fulfilment cost for the product shipped from the RDC 110 to the FDCs 130, the sale loss ratio incurred for the product when using the direct fulfilment from the RDC 110 to the FDCs 130 (or to the customers covered by the FDCs 130). Because each specific product has a corresponding SKU, product and SKU may be used interchangeably in this disclosure.

Those information in the demand forecast system 192, the inventory database 194, and the product database 196 are accessible by the inventory allocation computing device 150.

As shown in FIG. 4, the inventory allocation computing device 150 may include, without being limited to, a processor 152, a memory 154, and a storage device 156. In certain embodiments, the inventory allocation computing device 150 may include other hardware components and software components (not shown) to perform its corresponding tasks. Examples of these hardware and software components may include, but not limited to, other required memory, interfaces, buses, Input/Output (I/O) modules or devices, network interfaces, and peripheral devices. In certain embodiments, the inventory allocation computing device 150 is a cloud computer or a server computer, and the processor 152, the memory 154 and the storage device 156 are shared resources provided over the Internet on-demand.

The processor 152 may be a central processing unit (CPU) which is configured to control operation of the inventory allocation computing device 150. The processor 152 can execute an operating system (OS) or other applications of the inventory allocation computing device 150. In some embodiments, the inventory allocation computing device 150 may have more than one CPU as the processor, such as two CPUs, four CPUs, eight CPUs, or any suitable number of CPUs.

The memory 154 can be a volatile memory, such as the random-access memory (RAM), for storing the data and information during the operation of the inventory allocation computing device 150. In certain embodiments, the memory 154 may be a volatile memory array. In certain embodiments, the inventory allocation computing device 150 may run on more than one memory 154.

The storage device 156 is a non-volatile data storage media for storing the OS (not shown) and other applications of the inventory allocation computing device 150. Examples of the storage device 156 may include non-volatile memory such as flash memory, memory cards, USB drives, hard drives, floppy disks, optical drives, or any other types of data storage devices. In certain embodiments, the inventory allocation computing device 150 may have multiple storage devices 156, which may be identical storage devices or different types of storage devices, and the applications of the inventory allocation computing device 150 may be stored in one or more of the storage devices 156 of the inventory allocation computing device 150. As shown in FIG. 4, the storage device 156 includes a regional reserve stock engine (RRSE) 160. The RRSE 160 is configured to collect inventory, demand, cost/loss, etc., and provide RDC reserve ratio for the products in the RDC 110. In certain embodiments, the RRSE 160 is performed regularly, such as daily before delivery of products from the RDC 110 to the FDCs 130. For each time of updating, the RRSE 160 is configured to retrieve most current data or most recent historical data. In certain embodiments, the RRSE 160 is able to perform one round of computation in minutes. In certain embodiments, the RRSE 160 is programed to run once a day at a predetermined time.

In certain embodiments, the storage device 156 may include other modules, such as an allocation module 166 that uses the RDC reserve ratio as an input to provide allocation of certain quantity of products to different FDCs 130.

As shown in FIG. 4, the RRSE 160 includes, among other things, a data retrieve 162 and an RDC reserve ratio module 164. In certain embodiments, the RRSE 160 may include other applications or modules necessary for the operation of the modules 162 and 164. It should be noted that the modules are each implemented by computer executable codes or instructions, or data table or databases, which collectively forms one application. In certain embodiments, each of the modules may further include sub-modules. Alternatively, the modules may also be combined as one stack. In other embodiments, certain modules may be implemented as a circuit instead of executable code. In certain embodiments, some of the RRSE 160 may be located at a remote computing device, and the modules of the RRSE 160 in the local computing device 150 communicate with the modules in the remote computing device via a wired or wireless network. In certain embodiments, the inventory allocation computing device 150 is a cloud computer server.

The data retriever 162 is configured to, when the RRSE 160 is in operation, retrieve an estimated next inventory arrival time of a product based on VLT, a total current inventory of the product in the RDC 110, average demand forecast at the RDC 110 and the FDC 130 during a period from the current time to the arrival of the next inventory, demand variation, an average cancellation rate if the customer gives up the purchase due to a longer delivery time, and a cost ratio of the expediting transportation cost if shipping the product from the RDC 110 to the customer of the FDC 130 directly over the stockout cost of the product. The retrieval of the above information is described in more detail as follows.

In certain embodiments, the data retriever 162 is configured to retrieve the estimated next arrival time of the product from the VLT forecast system 190. For the product, there is a VLT estimation, which could be about 5-10 days and up to about one month. The VLT is the time needed from the placing of an order of the product by the RDC 110 and the delivery of the ordered product at the RDC 110. With the VLT available and the order placing time available, the VLT forecast system 190 can estimate the delivery time of the product, that is, the estimated next arrival time of the product. Subsequently, the data retriever 162 is configured to determine the time period from the current time to the next delivery time, which is the same as or less than the VLT. The time period is termed a predetermined time L. For example, if the RDC 110 places an order for a product at day 0, and the VLT for the product is 10 days, then the product will be delivered at day 10. If the current time is day 0, the data retriever 162 calculates the predetermined time L as 10 days; if the current time is day 3, the data retriever 162 calculates the predetermined time L as 7 days; and if the current time is day 7, the data retriever 162 calculates the predetermined time L as 3 days. The data retriever 162 can then use the calculated predetermined time L for retrieving specific demand forecast in the time L.

In certain embodiments, the data retriever 162 is configured to retrieve demand forecast at the RDC 110 and the FDC 130 from the demand forecast system 192. The forecast is made for the period from the current time to the estimated next arrival time of the product, that is, during the predetermined time L. The demand forecast system 192 is configured to provide demand forecast in time L based on historical sales and optionally future promotion information of the product. The demand forecast may be in a form of a daily quantity or daily average during the time L, or a total quantity during the time L. Because of the uncertainty of the forecast, the demand forecast may be a value, a range of values, or an average value and a variance. In certain embodiments, the value may be defined as a vector, each dimension of the vector corresponding to one specific number of units of the product, and the frequency of the numbers in the vector reflects the distribution of the forecast. In certain embodiments, the demand forecast vector has K dimensions, each dimension is named a scenario, and the scenario is indexed by k. In the kth scenario, the demand forecast for the RDC 110 during the time L is termed d₀^{k} and the demand forecast for the FDC 130 during the time L is termed d₁^{k}, and the data retriever 162 retrieves the demand forecast d₀^{k} and d₁^{k} from the demand forecast system 192.

The data retriever 162 is configured to retrieve the total current inventory of the product in the RDC 110 from the inventory database 194, which is termed inventory I. In certain embodiments, the inventory I indicates the total number of units of the product in the RDC 110. In certain embodiments, the inventory I may further include certain en route inventory, which will arrive the RDC 110 during the time L.

In certain embodiments, the data retriever 162 is configured to retrieve the average cancellation rate α if the customer gives up the purchase due to a longer delivery time from the product database 196. For example, for the customer 132 serviced by the FDC 130, the delivery time or shipping time of the product shown to the customer 132 may be one day if it is in stock at the FDC 130. If the product is out of stock at the FDC 130 but in stock at the RDC 110, the shipping time shown to the customer 132 may be correspondingly changed to three days due to the longer delivery distance from the RDC 110 to the customer 132 or other factors related to delivery directly from the RDC 110. When viewing the shipping of three days, the customer 132 might cancel the order or stop placing the order. The possibility of canceling the order by the customer 132 is named the cancellation rate α. In certain embodiments, the cancellation rate α is set at a range from 0 to about 0.2. In one embodiment, the cancellation rate α is set at 0.1, that is to say, when the customer 132 sees the longer delivery time, 10% of the time he will cancel the order. In certain embodiments, the total number of those possible orders that the product is out of stock at the FDC 130 but in stock at the RDC 110 is termed yₖ. As described above, the customers 132 may cancel the possible order due to the longer delivery time, and the canceled orders are estimated as yₖ×α; and the customers 130 may keep the orders regardless the longer delivery time, and the kept orders are estimated as yₖ×(1−α).

In certain embodiments, the data retriever 162 is configured to retrieve the cost ratio θ from the product database 196. When a customer 132 covered by the FDC 130 places an order of the product, and the product is out of stock in the FDC 130, the e-commerce platform would fulfill the order by the RDC 110, that is, shipping the product from the RDC 110 directly to the customer 132. Due to the longer delivery time and other factors related to the direct delivery from the RDC 110, the cost of delivering the product from the RDC 110 is normally higher than the cost of delivering the product from the FDC 130. The cost ratio θ is defined as the loss due to the high cost. In certain embodiments, the cost ratio θ is set at 0-0.5 of the unit price of the product. In certain embodiments, the cost ratio ∝ is set at 0.1.

After obtaining those information, the data retriever 162 is further configured to send the information to the RDC reserve ratio module 164.

The RDC reserve ratio module 164 is configured to, upon receiving the time period L, the demand forecasts d₀^{k} and d₁^{k} for the RDC 110 and the FDC 130 during the time period L, the inventory I of the RDC 110, the cancellation rate α due to out of stock of the product at the FDC 130, and the cost ratio cᵣ due to the direct fulfillment of the product by the RDC 110, optimize an object function using the parameters to obtain the reserve ratio at the RDC 110. The object function is defined as:

$$\begin{matrix}{min}_{δ , y} {{Σ}_{k} ( {d}_{0}^{k} + ( 1 - α ) {y}^{k} - {δ}_{0} I )}^{+} + {Σ}_{k} α {y}^{k} + {Σ}_{k} {c}_{r} min \{ ( 1 - α ) {y}^{k} , \frac{( 1 - α ) {d}_{1}^{k}}{{d}_{0}^{k} + ( 1 - α ) {d}_{1}^{k}} {( {δ}_{0} I - \frac{{d}_{0}^{k}}{{d}_{1}^{k}} {δ}_{1} I )}^{+} \} \\ s . t . \text{:} & ( 1 ) \\ {δ}_{0} + {δ}_{1} \leq 1 , & ( 1 a ) \\ {y}^{k} \geq {d}_{1}^{k} - {δ}_{1} I , ∀ k , and & ( 1 b ) \\ {y}^{k} \geq 0 \& {y}_{k} ∈ Z , ∀ k . & ( 1 c )\end{matrix}$$

In the formulas, I is a total current inventory of the product at the first level distribution center or RDC 110 and at the second level distribution center or FDCs 130, δ represents allocation ratio of the inventory I, δ₀ represents allocation ratio of the product for the RDC 110, δ₁ represents allocation ratio of the product for the second level distribution center(s) or FDC(s) 130; k is an index of scenarios being a positive integer from 1 to K, ∀k means for all the K scenarios; d₀^{k} is demand forecast for the RDC 110 under the kth scenario during the predetermined time L, and d₁^{k} is demand forecast of the FDC 130 under the kth scenario in the time L; and y^{k} represents sale loss of the product at the FDC 130 under the kth scenario, θ represents unit direct fulfilment cost for the product shipped from the RDC 110 to the customers 132 of the FDC 130 relative to the stockout cost, α represents sale loss ratio incurred when using direct fulfilment of the product from the RDC 110 instead of from the corresponding FDC 130.

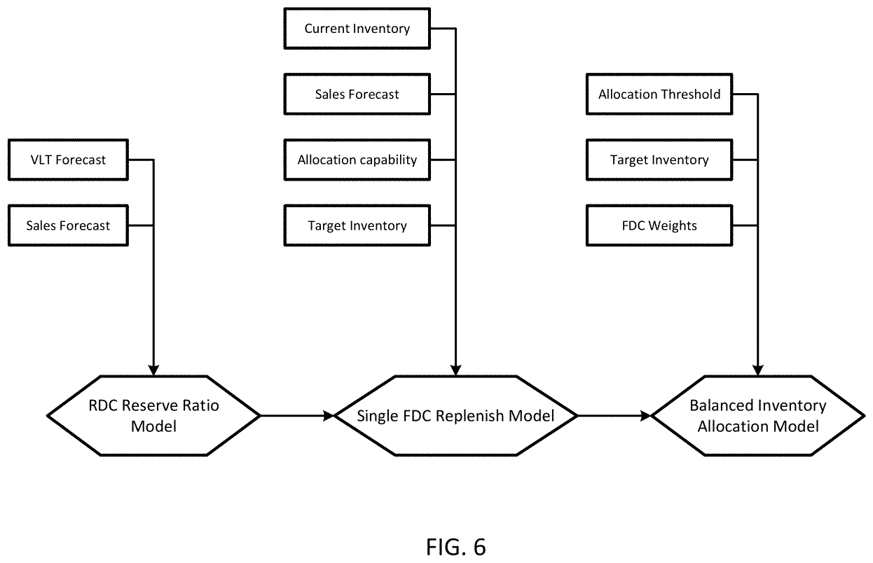

Kindly note I includes all the inventories in the RDC 110 and the FDCs 130, and the obtained optimal reserve ratio is relative to the total inventory I. In certain embodiments, based on the reserve ration relative to the total inventory I, the current inventory in the RDC 110, and the current inventories in the FDCs 130, a reserve ratio relative to the inventory in the RDC 110 can be calculated. The calculated reserve ratio relative to the RDC 110 inventory reflects how much of the RDC 110 inventory should be kept in the RDC 110 and how much of the RDC 110 inventory is available for being delivered to the FDCs 130. That reserve ratio of the RDC 110 relative to the RDC 110 inventory is useful for balanced inventory allocation by the balanced inventory allocation model shown in FIG. 6.

Further, θ represents unit direct fulfilment cost for the product shipped from the RDC 110 to the customers 132 of the FDC 130 over the stockout cost. The direct fulfilment cost for one unit of the product means the delivery cost from the RDC 110 minus the delivery cost from the FDC 130, that is, the extra cost due to shipment from the RDC 110 instead of from the FDC 130. The stockout cost is estimated as the profit of selling one unit of the product.

Furthermore, α represents sale loss ratio incurred when using direct fulfilment of the product from the RDC 110 instead of from the corresponding FDC 130. That is, for a certain number of units of the product that need to be shipped from the RDC 110 due to stockout of the product in the FDC 130, α percentage of them are lost due to cancellation or stop ordering of the order by the customers.

In the above formula (1), three cost components are considered in the minimization. The first component Σₖ(d₀^{k}+(1−α)y^{k}−δ₀I)⁺ is termed stockout cost incurred at the RDC 110, which indicates that when the demand forecast for the RDC 110 and the direct delivery of the product from the RDC 110 to the customers 132 are greater than the quantity of the product reserved in the RDC 110, the product is out of stock at the RDC 110, and there is a cost due to the out of stock. The second component Σₖαy^{k} is termed stockout cost incurred at FDC(s) 130, which indicates the cost related to the quantity of the short of supply of the product at the FDC 130 when the customers 132 place too many orders. In other words, when the customers 132 place or possibly would place a large number of orders greater than the inventory of the product at the FDC 130. The possible extra orders is the quantity of y^{k}, in which some of the y^{k} are placed by certain customers 132 regardless the longer delivery time from the RDC 110, and some of the y^{k} are canceled by certain customer 132 due to the longer delivery time from the RDC 110. Kindly note the variable y^{k} is an auxiliary variable in the analysis. The third component

$${Σ}_{k} θ min \{ ( 1 - α ) {y}^{k} , \frac{( 1 - α ) {d}_{1}^{k}}{{d}_{0}^{k} + ( 1 - α ) {d}_{1}^{k}} {( {δ}_{0} I - \frac{{d}_{0}^{k}}{{d}_{1}^{k}} {δ}_{1} I )}^{+} \}$$

is termed expediting delivery cost that the RDC 110 shipped to customers 132 directly, which indicates an extra cost due to the direct delivery from the RDC 110 compare to the direct delivery of the product from the FDC 130.

s.t. means such that. The formula (1a) indicates that the sum of the reserve ratio and the allocation ratio equals to or is less than 1. The formula (1b) defines for each kth scenario of all the K scenarios, the short of supply quantity y^{k} at the FDC 130 equals to or is greater than the demand forecast in the time L minus the allocation of the product to the FDC 130. The formula (1c) indicates that the short of supply quantity y^{k} is 0 or a positive integer.

The RDC reserve ratio module 164 is configured to, by optimizing the formula (1), obtains the reserve ratio δ₀ for the RDC 110 that minimize the value of the formula (1). The RDC reserve ratio module 164 may be further configured to send the obtained reserve ratio δ₀ to the allocation module 166, such that the allocation 166 can arrange the practical allocation of the product from the RDC 110 to the FDCs 130 based on the reserve ratio δ₀ and other necessary parameters.

Kindly note the RDC reserve ratio module 164 is configured to obtain the reserve ratio δ₀ for one product at a time, and by the same operation, can obtain the reserve ratio for all the other product or certain groups of product in the RDC 110. The RDC reserve ratio module 164 may obtain those reserve ratios for different products in the RDC 110 using parallel computation, or calculate those reserve ratios in a sequential order.

FIG. 5 depicts a method for inventory allocation according to certain embodiments of the present disclosure. In certain embodiments, a method 500 is implemented by the inventory allocation computing device 150 shown in FIG. 4. It should be particularly noted that, unless otherwise stated in the present disclosure, the steps of the method may be arranged in a different sequential order, and are thus not limited to the sequential order as shown in FIG. 5. Some detailed description which has been discussed previously may be omitted here for simplicity.

As shown in FIG. 5, at procedure 502, for one of the SKUs or products having the SKUs in an RDC 130, the data retriever 162 retrieves VLT of the product and the most recent order time of the product from the inventory database 194, determines the next inventory arrival time based on the VLT and the order time, and calculates the predetermined time L as from the current time to the next inventory arrival time.

At procedure 504, after calculating the predetermined time L, the data retriever 162 retrieves the demand forecast d₀^{k} of the RDC 110 and the demand forecast d₁^{k} of the FDC 130 from the demand forecast system 192.

At procedure 506, the data retriever 162 retrieves the current inventory I of the RDC 110 from the inventory database 194, and the cancellation rate α and cost ratio cᵣ from the product database 196.

The retrieval operation of the procedure 506 may be performed before, after, or at the same time as that of the procedure 502 and 504. After obtaining the parameters of the predetermined time L, the demand forecasts d₀^{k} and d₁^{k}, the cancellation rate α and cost ratio cᵣ, the data retriever 162 sends those parameters to the RDC reserve ratio module 164.

At procedure 508, in response to receiving those parameters, the RDC reserve ratio module 164 optimizes the object function of the formula (1) using the received parameters, to obtain the reserve ratio δ₀ of the product.

At procedure 510, the RDC reserve ratio module 164 may send the reserve ratio to the allocation module 166, such that the allocation module 166 can allocate the inventory I among the RDC 110 and the FDC(s) 130 based on the reserve ratio.

In certain embodiments, the RRSE 160 repeats the procedures 502 to 508 for each of the products in the RDC 110, and obtains the reserve ratios of those products. The allocation module 166 may consider the reserve ratios of all those products, and allocate those products for the next replenishment of the FDC(s) 130 from the RDC 110.

In a further aspect, the present invention is related to a non-transitory computer readable medium storing computer executable code. The code, when executed at a processer of a computing device, may perform the method 500 as described above. In certain embodiments, the non-transitory computer readable medium may include, but not limited to, any physical or virtual storage media. In certain embodiments, the non-transitory computer readable medium may be implemented as the storage device 156 of the inventory allocation computing device 150 as shown in FIG. 4.

In summary, the key advantage of applying RRSE is to calculate a near-optimal RDC reserve ratio for each product and each sales region automatically, incorporating various considerations that cannot be efficiently used by human decision makers, in order to provide a better inventory balance between the RDC and the FDCs.

The reserve ratio calculated above may be used as part of an inventory allocation system. FIG. 6 schematically depicts an inventory allocation system according to certain embodiments of the present disclosure. As shown in FIG. 6, the inventory allocation system includes an RDC reserve ratio model, a single FDC replenish model, and a balanced inventory allocation model. Certain embodiments of the present disclosure defines the operation of the RDC reserve ration model, and the RRSE 160 shown in FIG. 4 may correspond to the RDC reserve ratio model of FIG. 6.

The RDC reserve ratio model is configured to obtain the optimal reservation ratio of an SKU in the RDC 110 based on the forecast of the VLT and sales forecast based on the VLT of the SKU. Specifically, the optimal target allocation ratio of the SKU among the RDC 110 and the FDCs 130 may be calculated based on demands and inventory of the RDC 110 and FDCs 130, SKU unit price, direct fulfilment cost for a single SKU shipped from the RDC 110 instead of from corresponding one of the FDCs 130, and the sale loss ratio incurred when using the direct fulfilment from the RDC 110 to the FDCs 130. When the RDC reserve ratio model has calculated the optimal reservation ratio of an SKU, the quantity of the SKU that can be allocated to the FDCs 130 is determined. Then the single FDC replenish model can use the quantity of the SKU in the RDC 110 for further analysis.

The single FDC replenish model is configured to determine the replenishment quantity of the SKUs in an FDC 130 based on the current inventory, the sales forecast (or demand forecast), the allocation capacity and the target inventory of the SKUs. In certain embodiments, for each FDC 130, the single FDC replenish model determines the SKUs to be replenished based on the needs of the SKU (such as the demand forecast) instead of only based on the shortage of the SKU. Further, the single FDC replenish model controls the allocation quantity within a predetermined allocation quantity level.

The balanced inventory allocation model is configured to determine the allocation of an SKU to the FDCs 130 based on the allocation threshold and target inventory of the SKU, as well as the FDC weights. The balanced inventory allocation model not only considers the priority or weights of the FDCs 130, but also ensures balanced quantity of the SKU to all the FDCs 130.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for providing reserve ratio of a product in a first level distribution center, the method comprising:
providing, by a computing device, demand forecasts in a first predetermined time, inventory and sale loss data of the product in the first level distribution center and a second level distribution center, the second level distribution center covered by the first level distribution center;
defining, by the computing device, an object function comprising components of first level cost due to out of stock of the product at the first level distribution center, second level cost due to out of stock of the product at the second level distribution center, and delivery cost due to out of stock of the product at the second level distribution center and delivery of the product from the first level distribution center, using the demand forecasts, inventory and sale loss data of the product; and
minimizing the object function to obtain the reserve ratio of the product in the first level distribution center.

2. The method of claim 1, wherein the object function comprises:
$$\begin{matrix}{min}_{δ , y} {{Σ}_{k} ( {d}_{0}^{k} + ( 1 - α ) {y}^{k} - {δ}_{0} I )}^{+} + {Σ}_{k} α {y}^{k} + {Σ}_{k} θ min \{ ( 1 - α ) {y}^{k} , \frac{( 1 - α ) {d}_{1}^{k}}{{d}_{0}^{k} + ( 1 - α ) {d}_{1}^{k}} {( {δ}_{0} I - \frac{{d}_{0}^{k}}{{d}_{1}^{k}} {δ}_{1} I )}^{+} \} , \\ wherein \text{:} & ( 1 ) \\ {δ}_{0} + {δ}_{1} \leq 1 , & ( 1 a ) \\ {y}^{k} \geq {d}_{1}^{k} - {δ}_{1} I , ∀ k , and & ( 1 b ) \\ {y}^{k} \geq 0 , ∀ k , & ( 1 c )\end{matrix}$$
wherein I is a total current inventory of the product at the first level distribution center and the second level distribution center, δ represents allocation ratio of the inventory I, δ₀ represents allocation ratio of the product for the first level distribution center, δ₁ represents allocation ratio of the product for the second level distribution center;
wherein k is an index of scenarios being a positive integer from 1 to K, ∀k means for all the K scenarios;
wherein d₀^{k} is demand forecast of the first level distribution center under a kth scenario in a predetermined time, and d₁^{k} is demand forecast of the second level distribution center under the kth scenario in the predetermined time; and
wherein y^{k} represents sale loss of the product at the second level distribution center under the kth scenario, θ represents ratio of expediting transportation cost if shipping the product directly from the first level distribution center to a customer ordering the product over stockout cost of the product in the first level distribution center, α represents cancellation rate incurred due to stockout of the product in the second level distribution center.

3. The method of claim 2, wherein θ is 10%-50% of a unit price of the product.

4. The method of claim 3, wherein α is in a range of 0-0.2.

5. The method of claim 4, wherein θ is 10% of the unit price of the product and α is 0.1.

6. The method of claim 2, wherein K is in a range of 50-200.

7. The method of claim 6, wherein K is about 100.

8. The method of claim 1, wherein each of the demand forecasts is a vector comprising K scenarios.

9. The method of claim 1, wherein the predetermined time is in a range of one day to seven days.

10. The method of claim 9, wherein the predetermined time is two days.

11. The method of claim 1, further comprising: allocating the product from the first level distribution center to the second level distribution center based on the reserve ratio.

12. A system for providing reserve ratio of a product in a first level distribution center, the system comprising a computing device, the computing device comprising a processor and a storage device storing computer executable code, wherein the computer executable code, when executed at the processor, is configured to:
provide demand forecasts in a first predetermined time, inventory and sale loss data of the product in the first level distribution center and a second level distribution center, the second level distribution center covered by the first level distribution center;
define an object function comprising components of first level cost due to out of stock of the product at the first level distribution center, second level cost due to out of stock of the product at the second level distribution center, and delivery cost due to out of stock of the product at the second level distribution center and delivery of the product from the first level distribution center, using the demand forecasts, inventory and sale loss data of the product; and
minimize the object function to obtain the reserve ratio of the product in the first level distribution center.

13. The system of claim 12, wherein object function comprises:
$$\begin{matrix}{min}_{δ , y} {{Σ}_{k} ( {d}_{0}^{k} + ( 1 - α ) {y}^{k} - {δ}_{0} I )}^{+} + {Σ}_{k} α {y}^{k} + {Σ}_{k} θ min \{ ( 1 - α ) {y}^{k} , \frac{( 1 - α ) {d}_{1}^{k}}{{d}_{0}^{k} + ( 1 - α ) {d}_{1}^{k}} {( {δ}_{0} I - \frac{{d}_{0}^{k}}{{d}_{1}^{k}} {δ}_{1} I )}^{+} \} , \\ wherein \text{:} & ( 1 ) \\ {δ}_{0} + {δ}_{1} \leq 1 , & ( 1 a ) \\ {y}^{k} \geq {d}_{1}^{k} - {δ}_{1} I , ∀ k , and & ( 1 b ) \\ {y}^{k} \geq 0 , ∀ k , & ( 1 c )\end{matrix}$$
wherein I is a total current inventory of the product at the first level distribution center and the second level distribution center, δ represents allocation ratio of the inventory I, δ₀ represents allocation ratio of the product for the first level distribution center, δ₁ represents allocation ratio of the product for the second level distribution center;
wherein k is an index of scenarios being a positive integer from 1 to K, ∀k means for all the K scenarios;
wherein d₀^{k} is demand forecast of the first level distribution center under a kth scenario in a predetermined time, and d₁^{k} is demand forecast of the second level distribution center under the kth scenario in the predetermined time; and
wherein y^{k} represents sale loss of the product at the second level distribution center under the kth scenario, θ represents ratio of expediting transportation cost if shipping the product directly from the first level distribution center to a customer ordering the product over stockout cost of the product in the first level distribution center, α represents cancellation rate incurred due to stockout of the product in the second level distribution center.

14. The system of claim 13, wherein θ is 10%-50% of a unit price of the product, α is in a range of 0-0.2 and K is in a range of 50-200.

15. The system of claim 12, wherein each of the demand forecasts is a vector comprising K scenarios.

16. The system of claim 12, wherein the predetermined time is in a range of one day to seven days.

17. The system of claim 12, wherein the computer executable code is further configured to: allocate the product from the first level distribution center to the second level distribution center based on the reserve ratio

18. A non-transitory computer readable medium storing computer executable code, wherein the computer executable code, when executed at a processor of a computing device, is configured to:
provide demand forecasts in a first predetermined time, inventory and sale loss data of the product in the first level distribution center and a second level distribution center, the second level distribution center covered by the first level distribution center;
define an object function comprising components of first level cost due to out of stock of the product at the first level distribution center, second level cost due to out of stock of the product at the second level distribution center, and delivery cost due to out of stock of the product at the second level distribution center and delivery of the product from the first level distribution center, using the demand forecasts, inventory and sale loss data of the product; and
minimize the object function to obtain the reserve ratio of the product in the first level distribution center.

19. The non-transitory computer readable medium of claim 18, wherein the object function comprises:
$$\begin{matrix}{min}_{δ , y} {{Σ}_{k} ( {d}_{0}^{k} + ( 1 - α ) {y}^{k} - {δ}_{0} I )}^{+} + {Σ}_{k} α {y}^{k} + {Σ}_{k} θ min \{ ( 1 - α ) {y}^{k} , \frac{( 1 - α ) {d}_{1}^{k}}{{d}_{0}^{k} + ( 1 - α ) {d}_{1}^{k}} {( {δ}_{0} I - \frac{{d}_{0}^{k}}{{d}_{1}^{k}} {δ}_{1} I )}^{+} \} , \\ wherein \text{:} & ( 1 ) \\ {δ}_{0} + {δ}_{1} \leq 1 , & ( 1 a ) \\ {y}^{k} \geq {d}_{1}^{k} - {δ}_{1} I , ∀ k , and & ( 1 b ) \\ {y}^{k} \geq 0 , ∀ k , & ( 1 c )\end{matrix}$$
wherein I is a total current inventory of the product at the first level distribution center and the second level distribution center, δ represents allocation ratio of the inventory I, δ₀ represents allocation ratio of the product for the first level distribution center, δ₁ represents allocation ratio of the product for the second level distribution center;
wherein k is an index of scenarios being a positive integer from 1 to K, ∀k means for all the K scenarios;
wherein d₀^{k} is demand forecast of the first level distribution center under a kth scenario in a predetermined time, and d₁^{k} is demand forecast of the second level distribution center under the kth scenario in the predetermined time; and
wherein y^{k} represents sale loss of the product at the second level distribution center under the kth scenario, θ represents ratio of expediting transportation cost if shipping the product directly from the first level distribution center to a customer ordering the product over stockout cost of the product in the first level distribution center, α represents cancellation rate incurred due to stockout of the product in the second level distribution center.

20. The non-transitory computer readable medium of claim 19, wherein the predetermined time is in a range of one day to seven days, θ is 10%-50% of a unit price of the product, α is in a range of 0-0.2, each of the demand forecasts is a vector comprising K scenarios, and K is in a range of 50-200.
